(19) United States
(12) Patent Application Publication
(10) Pub. No.: US 2013/0140125 A1
(43) Pub. Date: Jun. 6, 2013

(54) CLUTCH COVER ASSEMBLY

(71) Applicants: Hirokazu Wakabayashi, Neyagawa-shi (JP); Norihiko Tanigawa, Suzuka-shi (JP); Nobuhiko Matsumoto, Neyagawa-shi (JP)

(72) Inventors: Hirokazu Wakabayashi, Neyagawa-shi (JP); Norihiko Tanigawa, Suzuka-shi (JP); Nobuhiko Matsumoto, Neyagawa-shi (JP)

(73) Assignee: EXEDY CORPORATION, Neyagawa-shi, Osaka (JP)

(21) Appl. No.: 13/817,093

(22) PCT Filed: Jun. 20, 2011
(86) PCT No.: PCT/JP2011/064069

§ 371 Date: Feb. 14, 2013

(30) Foreign Application Priority Data
Aug. 20, 2010 (JP) 2010-185102

(51) Int. Cl. F16D 13/75

(52) U.S. Cl. CPC F16D 13/757
USPC 192/66.31

(57) ABSTRACT

A clutch cover assembly is equipped with a clutch cover that is fixed to a flywheel, a pressure plate, a fulcrum ring, and a ring movement regulating mechanism. The pressure plate is for pressing a friction member against the flywheel and is coupled to the clutch cover in such a way as to be relatively non-rotatable with respect to the clutch cover. The fulcrum ring is placed on the pressure plate and moves in a direction away from the pressure plate in accordance with the wear-amount of the friction member. The ring movement regulating mechanism regulates the movement of the fulcrum ring in the direction away from the pressure plate when the rotational speed of the pressure plate has exceeded a predetermined rotational speed.

### CROSS-REFERENCE TO RELATED APPLICATIONS

This national phase application claims priority to Japanese Patent Application No. 2010-185102 filed on Aug. 20, 2010. The entire disclosure of Japanese Patent Application No. 2010-185102 is hereby incorporated herein by reference.

### BACKGROUND

1. Technical Field

The present invention relates to a clutch cover assembly and particularly a clutch cover assembly for pressing a friction member of a clutch disc assembly against a flywheel of an engine and releasing the pressing.

2. Background Art

A clutch cover assembly is generally attached to a flywheel of an engine and used for transmitting the driving force of the engine to a transmission side. The clutch cover assembly is mainly equipped with a clutch cover, a pressure plate, and a diaphragm spring. The clutch cover is fixed to the flywheel. The pressure plate is pressed to the flywheel side by the diaphragm spring and holds a friction member of a clutch disc assembly between itself and the flywheel. The diaphragm spring has the function of pressing the pressure plate and also has a lever function for releasing the pressing on the pressure plate.

Here, when the wear of the friction member of the clutch disc assembly advances due to the load characteristic of the diaphragm spring, the pressing load on the friction member becomes greater. For this reason, when the friction member wears, a large load becomes necessary to perform the release operation, and the clutch pedal pressure ends up becoming greater.

Thus, as described in patent citation 1 for example, there has been proposed a wear compensating mechanism that is configured to suppress the pressing load from becoming greater by returning the posture of the diaphragm spring to an initial state even in a case where the friction member has worn. The wear compensating mechanism mainly has a fulcrum ring that is placed between the pressure plate and the diaphragm spring, a biasing mechanism that biases the fulcrum ring in a direction away from the pressure plate, and a wear-amount detecting mechanism that detects the wear-amount of the friction member. Here, the diaphragm spring is capable of pressing the pressure plate via the fulcrum ring, and by moving the fulcrum ring to the side away from the pressure plate in accordance with the wear-amount of the friction member, the diaphragm spring is maintained in its initial set posture.

Further, in order to remedy instability in the operation of the wear-amount detecting mechanism caused by vibration, the wear compensating mechanism described in patent citation 2 has also been proposed. Here, a cone spring for absorbing vibration is disposed in the wear-amount detecting mechanism to stabilize the operation for wear compensation

### CITATION LIST

### Patent Literature

Patent citation 1: JP-A No. 10-227317
Patent citation 2: JP-A No. 2003-28193

### SUMMARY

### Technical Problem

In the wear compensating mechanisms described above, precisely detecting the wear-amount is important. In patent citations 1 and 2, the wear-amount detecting mechanisms are configured by a bush and a bolt that penetrates the bush, and the wear-amount is detected by the interstice between both that arises in accordance with wear. However, in the conventional configurations described above, there is the concern that the interstice indicating the wear-amount will change due to vibration of each portion accompanying the engine vibration or the like, and stably performing accurate wear compensation is difficult.

It is a problem of the present invention to make it possible to perform accurate wear compensation.

### Solution to Problem

A clutch cover assembly pertaining to a first aspect of the invention is for pressing a friction member of a clutch disc assembly against a flywheel of an engine and releasing the pressing.

The clutch cover assembly is equipped with a clutch cover that is fixed to the flywheel, a pressure plate, a fulcrum ring, and a ring movement regulating mechanism. The pressure plate is for pressing the friction member against the flywheel and is coupled to the clutch cover in such a way as to be relatively non-rotatable with respect to the clutch cover. The fulcrum ring is placed on the pressure plate and moves in a direction away from the pressure plate in accordance with the wear-amount of the friction member. The ring movement regulating mechanism regulates the movement of the fulcrum ring in the direction away from the pressure plate in a state in which the rotational speed of the pressure plate has exceeded a predetermined rotational speed.

In this clutch cover assembly, when the pressure plate presses the friction member against the flywheel, the pressure plate rotates together with the flywheel via the friction member. If the rotational speed of the pressure plate exceeds the predetermined rotational speed when the pressure plate is rotating in this way, the movement of the fulcrum ring in the direction away from the pressure plate is regulated by the ring movement regulating mechanism. Here, the movement of the fulcrum ring in the direction away from the pressure plate in accordance with the amount of the wear of the friction member is regulated.

In this way, in the present invention, the movement of the fulcrum ring is regulated by the ring movement regulating mechanism when the rotational speed of the pressure plate exceeds the predetermined rotational speed. Therefore, even if vibration occurs in the clutch cover assembly in this state, it becomes difficult for the fulcrum ring to be affected by the vibration. That is, in the present invention, the effect of vibration can be eliminated by the ring movement regulating mechanism, so accurate wear compensation can be performed.

A clutch cover assembly pertaining to a second aspect of the invention is the clutch cover assembly according to the first aspect of the invention, wherein the ring movement regulating mechanism has an engaging member that engages with the fulcrum ring and a regulating member that engages with the engaging member and regulates the movement of the fulcrum ring via the engaging member in the state in which the rotational speed of the pressure plate has exceeded the predetermined rotational speed.

In this clutch cover assembly, the regulating member engages with the engaging member and regulates the movement of the fulcrum ring via the engaging member in the state in which the rotational speed of the pressure plate has exceeded the predetermined rotational speed. Therefore, even if vibration occurs in this state, it becomes difficult for the fulcrum ring to be affected by the vibration. In other words, when the engagement between the regulating member and the engaging member has been released, the fulcrum ring can be moved in accordance with the wear-amount of the friction member. Therefore, wear compensation can be performed more reliably.

A clutch cover assembly pertaining to a third aspect of the invention is the clutch cover assembly according to the second aspect of the invention, wherein the fulcrum ring moves in the direction away from the pressure plate as a result of being relatively rotated with respect to the pressure plate in accordance with the wear-amount of the friction member. The engaging member is attached to the pressure plate in such a way as to be movable in a rotational direction of the fulcrum ring. The regulating member is attached, in such a way that it can freely swing, to the pressure plate and regulates the movement of the engaging member by swinging and engaging with the engaging member in the state in which the rotational speed of the pressure plate has exceeded the predetermined rotational speed.

In this clutch cover assembly, in a case where the regulating member swings and engages with the engaging member in the state in which the rotational speed of the pressure plate has exceeded the predetermined rotational speed, the movement of the engaging member is regulated by the regulating member. For this reason, the movement of the fulcrum ring is also regulated by the regulating member via the engaging member. On the other hand, in a case where the engagement of the regulating member with respect to the engaging member has been released, the engaging member moves in the rotational direction of the fulcrum ring. Then, the fulcrum ring becomes relatively rotatable with respect to the pressure plate and moves in the direction away from the pressure plate in accordance with the wear-amount of the friction member.

In this way, in the present invention, when the regulating member swings due to centrifugal force and engages with the engaging member, the movement of the fulcrum ring can be regulated, and when the engagement of the regulating member with respect to the engaging member has been released, the fulcrum ring can be moved in the direction away from the pressure plate. That is, in the present invention, when the effect of vibration is large, the movement of the fulcrum ring can be regulated, and when the effect of vibration is small, wear compensation can be safely and accurately performed by moving the fulcrum ring.

A clutch cover assembly pertaining to a fourth aspect of the invention is the clutch cover assembly according to the third aspect of the invention, wherein the regulating member has an adjusting member whose weight has been adjusted in such a way that the regulating member swings due to centrifugal force when the rotational speed of the pressure plate has become greater than the predetermined rotational speed.

In this clutch cover assembly, the adjusting member is disposed on the regulating member, and the timing when the regulating member swings due to centrifugal force is adjusted by the adjusting member. Here, when the rotational speed of the pressure plate has become greater than the predetermined rotational speed, the regulating member swings due to centrifugal force. Because of this, when the rotational speed is a rotational speed at which the effect of vibration is large, the movement of the fulcrum ring can be regulated, and when the rotational speed is a rotational speed at which the effect of vibration is small, the fulcrum ring can be moved. For example, when the rotational speed of the pressure plate has become greater than the idling engine speed, the regulating member can be allowed to engage with the engaging member. Further, when the rotational speed of the pressure plate has become equal to or less than the idling engine speed, the engagement between the regulating member and the engaging member can be released. Because of this, practical wear compensation can be performed.

A clutch cover assembly pertaining to the fifth aspect of the invention is the clutch cover assembly according to the third or fourth aspect of the invention, wherein the ring movement regulating mechanism further has a first biasing member that is attached to the pressure plate and biases the regulating member in a direction away from the engaging member.

In this clutch cover assembly, in the ring movement regulating mechanism, the first biasing member attached to the pressure plate biases the regulating member in the direction away from the engaging member, so the engagement between the regulating member and the engaging member can be reliably released. Because of this, the fulcrum ring can be reliably moved. Therefore, wear compensation can be performed more safely and more accurately.

A clutch cover assembly pertaining to a sixth aspect of the invention is the clutch cover assembly according to any of the third to fifth aspects of the invention, wherein the ring movement regulating mechanism further has a second biasing member that biases the engaging member in the rotational direction of the fulcrum ring.

In this clutch cover assembly, in the ring movement regulating mechanism, the second biasing member biases the engaging member in the rotational direction of the fulcrum ring. Therefore, when the engagement between the regulating member and the engaging member has been released, the engaging member can be speedily moved in the rotational direction of the fulcrum ring. Further, in this state, the fulcrum ring is rotated in the moving direction of the engaging member in accordance with the wear-amount of the friction member, whereby the fulcrum ring can be reliably moved in the direction away from the pressure plate. In this way, the fulcrum ring can be made to smoothly track the wear of the friction member.

A clutch cover assembly pertaining to a seventh aspect of the invention is the clutch cover assembly according to any of the second to sixth aspects of the invention, wherein the ring movement regulating mechanism further has a release member that releases the engagement of the regulating member with respect to the engaging member and a third biasing member that biases the release member in the direction away from the engaging member. The release member is in contact with the regulating member, is biased in the direction away from the engaging member by the third biasing member, and releases the engagement of the regulating member with respect to the engaging member.

In this clutch cover assembly, the third biasing member biases the release member in the direction away from the engaging member in a state in which the release member is in contact with the regulating member, whereby the engagement of the regulating member with respect to the engaging member is released. Because of this, the fulcrum ring can be reliably moved. Therefore, wear compensation can be performed more safely and more accurately.

A clutch cover assembly pertaining to an eighth aspect of the invention is the clutch cover assembly according to the seventh aspect of the invention, wherein a step portion is formed on the pressure plate. A posture holding portion that engages with the step portion and holds the posture in which the regulating member is engaged with the engaging member is formed on the regulating member. The release member is attached, in such a way that it can freely swing, to the pressure plate between the regulating member and the pressure plate. The release member is swung in the direction away from the engaging member by the third biasing member and releases the engagement between the step portion of the pressure plate and the posture holding portion of the regulating member.

In this clutch cover assembly, when the posture holding portion of the regulating member is engaged with the step portion of the pressure plate, the posture in which the regulating member is engaged with the engaging member is held. Further, when the release member has swung in the direction away from the engaging member due to the third biasing member, the engagement between the regulating member and the engaging member is released. Because of this, when the effect of vibration is large, the movement of the fulcrum ring is regulated by holding the posture in which the regulating member is engaged with the engaging member, and when the effect of vibration is small, wear compensation can be performed more safely and accurately by releasing the engagement between the regulating member and the engaging member.

A clutch cover assembly pertaining to a ninth aspect of the invention is the clutch cover assembly according to any of the first to eighth aspects of the invention and is further equipped with a pressing member, a wear-amount detecting mechanism, and a wear tracking mechanism. The pressing member is for pressing the pressure plate to the flywheel side and is supported on the clutch cover. The wear-amount detecting mechanism is for detecting the wear-amount of the friction member in a state in which the friction member is pressed against the flywheel. The wear tracking mechanism has the fulcrum ring. The wear tracking mechanism moves the pressing member to an initial posture side by moving the fulcrum ring in the direction away from the pressure plate in accordance with the wear-amount of the friction member in a state in which the pressing of the friction member against the flywheel has been released.

In this clutch cover assembly, the wear-amount of the friction member is detected in a state in which the friction member is pressed against the flywheel. Here, in the ring movement regulating mechanism, even if vibration occurs at the time of rotation of the pressure plate in a case where the rotational speed of the pressure plate exceeds the predetermined rotational speed and the movement of the fulcrum ring is being regulated, it is difficult for the fulcrum ring to be affected by the vibration.

Further, in a state in which the regulation of the movement of the fulcrum ring has been released and the pressing of the friction member against the flywheel has been released, the fulcrum ring is moved in the direction away from the pressure plate in accordance with the wear-amount of the friction member. That is, in a state in which the effect of vibration is small, the fulcrum ring is moved in the direction away from the pressure plate. For this reason, wear compensation can be performed more reliably.

A clutch cover assembly pertaining to a tenth aspect of the invention is the clutch cover assembly according to the ninth aspect of the invention, wherein the wear tracking mechanism further has sliding portions and a fourth biasing member. The sliding portions are sections that are formed on the pressure plate and the fulcrum ring and are in contact with and slide against each other. The fourth biasing member biases the fulcrum ring in a circumferential direction and relatively rotates the fulcrum ring with respect to the pressure plate. The sliding portions include sloping surfaces that slope along the circumferential direction. The fourth biasing member moves the fulcrum ring in the direction away from the pressure plate by rotating the fulcrum ring in accordance with the wear-amount of the friction member.

In this clutch cover assembly, the fulcrum ring is relatively rotated with respect to the pressure plate by the fourth biasing member in accordance with the wear-amount of the friction member. The fulcrum ring and the pressure plate are in contact with each other at the sliding portions that include sloping surfaces, so when the fulcrum ring is rotated with respect to the pressure plate, the fulcrum ring moves to the side away from the pressure plate. Because of this, even when the friction member wears, the position at which the fulcrum ring supports the pressing member does not change from the initial posture. For this reason, the pressing load characteristic, and therefore the release load characteristic, can be maintained in the initial state.

### BRIEF DESCRIPTION OF THE DRAWINGS

FIG. 1 is a front view of a clutch cover assembly pertaining to a first embodiment of the present invention;

FIG. 2 is an exploded perspective view of the clutch cover assembly;

FIG. 3 is a partially enlarged view of a pressure plate and a fulcrum ring;

FIG. 4 is a partial cross-sectional perspective view showing a support structure of a diaphragm spring;

FIG. 5 is an enlarged perspective view of a wear-amount detecting mechanism;

FIG. 6 is a view showing the configuration of the wear-amount detecting mechanism;

FIG. 7 is a view for describing the configuration and action of a ring movement regulating mechanism;

FIG. 8 is a view for describing the configuration and action of the ring movement regulating mechanism;

FIG. 9 is a view for describing the actions of the wear-amount detecting mechanism, the ring movement regulating mechanism, and a wear tracking mechanism;

FIG. 10 is a view for describing the actions of the wear-amount detecting mechanism, the ring movement regulating mechanism, and the wear tracking mechanism;

FIG. 11 is a view for describing the configuration and action of a ring movement regulating mechanism according to a second embodiment of the present invention; and

FIG. 12 is a view for describing the configuration and action of the ring movement regulating mechanism according to the second embodiment of the present invention.

### DETAILED DESCRIPTION OF PREFERRED EMBODIMENTS

### Embodiment 1

### Overall Configuration

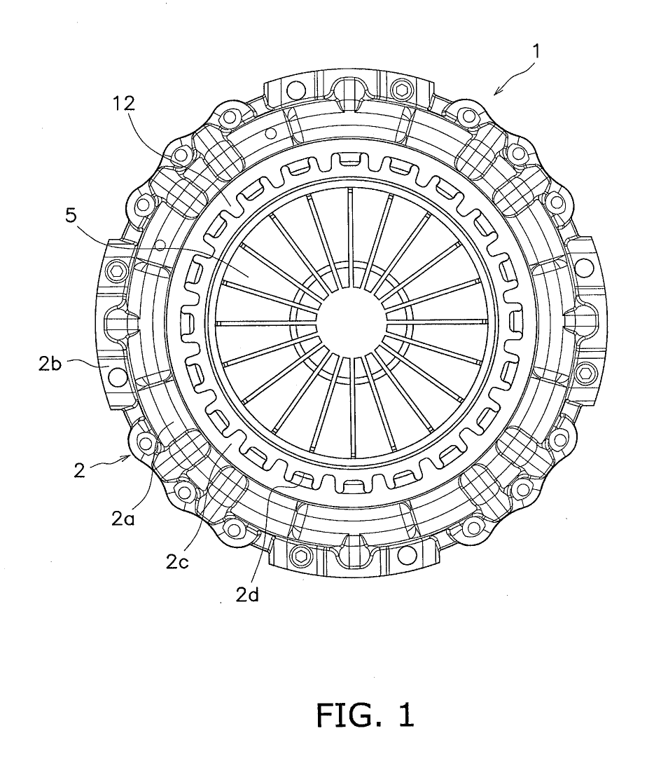

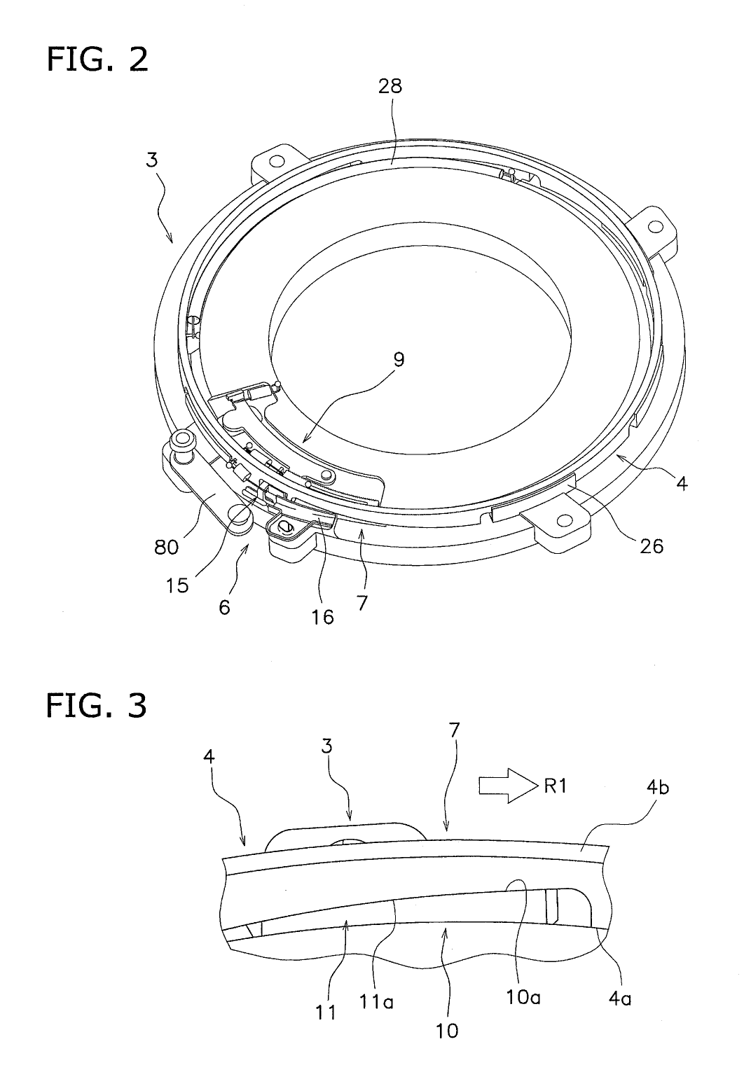

FIG. 1 shows a front view of a clutch cover assembly 1 according to a first embodiment of the present invention. Further, FIG. 2 shows an external perspective view in which part of the clutch cover assembly 1 is omitted. The clutch cover assembly 1 is a device for pressing a friction member of a clutch disc assembly against a flywheel of an engine at a time when the clutch is on (power is transmitted) and releasing the pressing at a time when the clutch is off (the transmission of power is cut off). Here, the flywheel and the clutch disc assembly are omitted.

The clutch cover assembly 1 is mainly configured from a clutch cover 2, a pressure plate 3, plural fulcrum ring 4 segments, a diaphragm spring 5, a wear-amount detecting mechanism 6, and a wear tracking mechanism 7 that includes the plural fulcrum ring 4 segments.

### Clutch Cover

The clutch cover 2 is a generally dish-shaped plate member, and its outer peripheral portion is fixed to the flywheel by bolts, for example. The clutch cover 2 has an annular clutch cover body 2a, a disc-shaped portion 2b on the outer peripheral side, and a flat portion 2c on the inner peripheral side. The disc-shaped portion 2b is formed on the outer peripheral side of the clutch cover body 2a and is fixed to the outer peripheral portion of the flywheel. The flat portion 2c is a flat section that extends inward in the radial direction from the inner peripheral portion of the clutch cover body 2a. Plural holes 2d that penetrate the flat portion 2c in the axial direction are formed in the flat portion 2c.

### Pressure Plate

The pressure plate 3 is an annular member and is placed inside the clutch cover body 2a of the clutch cover 2. On the surface on the flywheel side (the reverse side in FIG. 2) of the pressure plate 3, a friction surface (not shown in the drawings) that slidingly contacts the friction member of the clutch disc assembly is formed. Further, the pressure plate 3 is coupled to the clutch cover 2 by plural strap plates 80 (see FIG. 2; just one is shown in FIG. 2), is movable in the axial direction with respect to the clutch cover 2, and is relatively non-rotatable in the circumferential direction with respect to the clutch cover 2. In a state in which the clutch is coupled, the strap plates bend in the axial direction, and the pressure plate 3 is biased to the side away from the flywheel by the bending (resilience) of the strap plates.

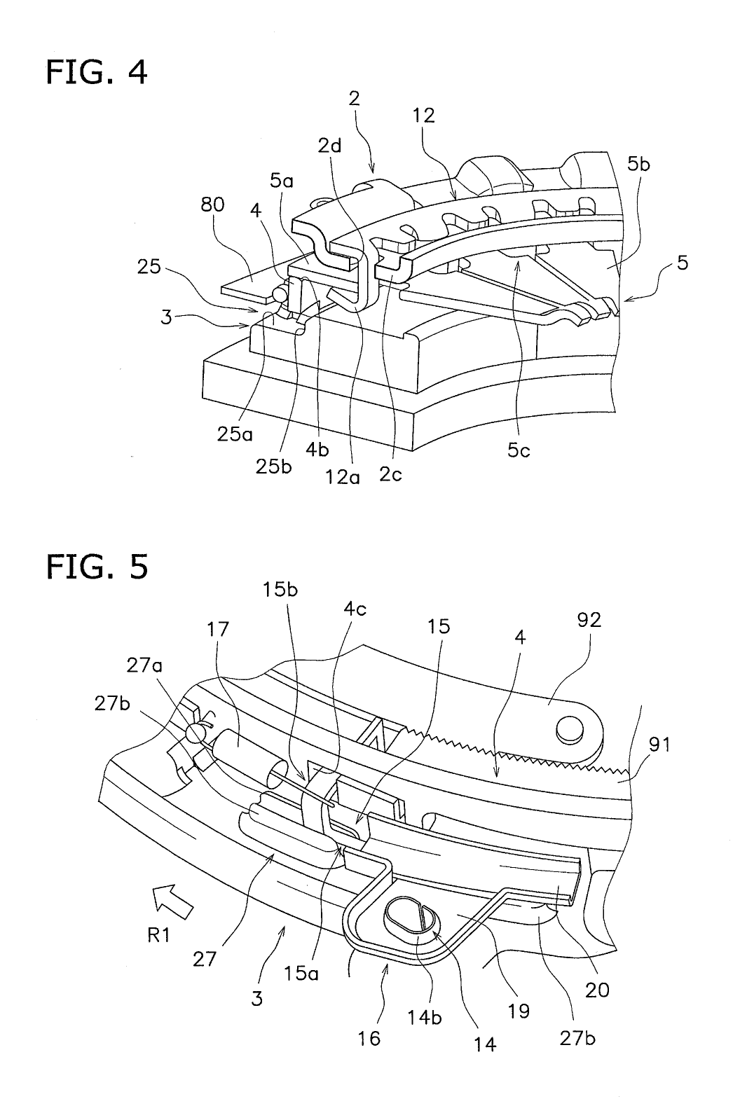

Further, on the surface on the transmission side (the front side in FIG. 2) of the pressure plate 3, as shown in FIG. 3, sliding portions 10 are formed in plural places in the circumferential direction on the outer peripheral side. Specifically, each sliding portion 10 is formed projecting outward in the axial direction from a bottom portion 25a of a step portion 25 described later. Each sliding portion 10 has a sloping surface 10a that slopes in such a way that its height becomes higher in a first circumferential direction (the direction of R1 in FIG. 3). Further, as shown in FIG. 4, on the surface on the transmission side of the pressure plate 3, the step portion 25 is formed in the circumferential direction on the outer peripheral side. Further, on the surface on the transmission side of the pressure plate 3, guide portions 26 are formed in plural places in the circumferential direction on the outer peripheral side (see FIG. 2). The guide portions 26 are formed on the pressure plate 3 in such a way as to oppose a wall portion 25b of the step portion 25.

Moreover, as shown in FIG. 5, plural rail portions—for example, two sets of rail portions—27 are disposed on the pressure plate 3. Each set of rail portions 27 has a pair of two projecting portions 27a and 27b that are formed opposing each other. The two projecting portions 27a and 27b in each pair are disposed on the pressure plate 3 in positions a predetermined interval apart from each other. A wedge member 15 described later is placed between the two projecting portions 27a and 27b in each pair.

### Fulcrum Ring

The plural fulcrum ring 4 segments are circular arc-shaped members, that is, members formed by dividing an annular member in the circumferential direction. As shown in FIG. 3 and FIG. 4, an axial-direction first end side 4a (the flywheel side) of the plural fulcrum ring 4 segments is placed on the bottom portion 25a of the step portion 25 of the pressure plate 3. More specifically, the plural fulcrum ring 4 segments are placed on the bottom portion 25a of the step portion 25 between the wall portion 25b of the step portion 25 of the pressure plate 3 and the guide portions 26.

Further, as is apparent from FIG. 3, sliding portions 11 are formed in plural places in the circumferential direction on the first end 4a of the fulcrum ring 4. The sliding portions 11 have sloping surfaces 11a. The sloping surfaces 11a are in contact with the sloping surfaces 10a of the sliding portions 10 formed on the bottom portion 25a of the step portion 25 of the pressure plate 3 and slope in such a way that their height becomes lower in the first circumferential direction (the direction of R1 in FIG. 3). Further, as shown in FIG. 5, an engaging recessed portion 4c with which the wedge member 15 described later engages is formed in the fulcrum ring 4. Specifically, the engaging recessed portion 4c is a section that has been cut out in the shape of a groove in the radial direction in the first end 4a of the fulcrum ring 4. The engaging recessed portion 4c has a width W1 in the circumferential direction.

Here, an annular member is formed by arranging the plural fulcrum ring 4 segments (circular arc-shaped members) one after another, but a single annular member can also be used as the fulcrum ring.

### Diaphragm Spring

As shown in FIG. 1 and FIG. 4, the diaphragm spring 5 is a disc-shaped member placed between the pressure plate 3 and the clutch cover 2. The diaphragm spring 5 is configured from an annular elastic portion 5a and plural lever portions 5b that extend inward in the radial direction from the inner peripheral portion of the annular elastic portion 5a. The outer peripheral end of the annular elastic portion 5a is supported on a second end 4b of the fulcrum ring 4. Further, slits are formed between the lever portions 5b of the diaphragm spring 5, and oval holes 5c are formed in the outer peripheral portions of the slits.

A push-type release device (not shown in the drawings) is in contact with the distal ends of the lever portions 5b of the diaphragm spring 5. The release device is a device for moving the distal ends of the lever portions 5b of the diaphragm spring 5 in the axial direction to thereby release the biasing force on the pressure plate 3 resulting from the diaphragm spring 5.

Further, as shown in FIG. 4, the diaphragm spring 5 is supported on the clutch cover 2 by a support member 12. The support member 12 is a ring-shaped plate member placed on the surface on the transmission side of the flat portion 2c of the clutch cover 2. Plural support projections 12a that extend inward in the radial direction are formed on the inner peripheral portion of the support member 12. The plural support projections 12a are bent to the pressure plate 3 side, and the bent portions are inserted through plural through holes 2d formed in the flat portion 2c of the clutch cover 2. Further, the bent portions inserted through the through holes 2d are further inserted through the oval holes 5c in the diaphragm spring 5. Additionally, the distal ends of the support projections 12a are bent toward the outer peripheral side and support the diaphragm spring 5 with respect to the clutch cover 2.

### Wear-Amount Detecting Mechanism

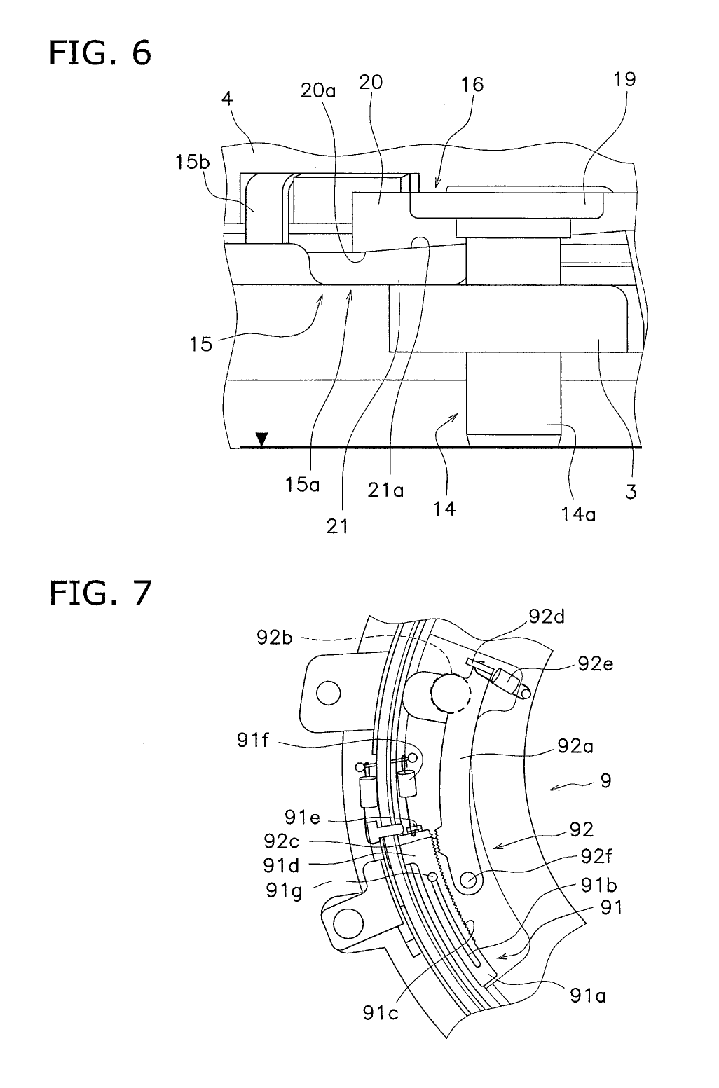

As shown in FIG. 2, FIG. 5 and FIG. 6, and FIG. 9 and FIG. 10, the wear-amount detecting mechanism 6 is placed on the outer peripheral portion of the fulcrum ring 4. The wear-amount detecting mechanism 6 is a mechanism that detects the wear-amount of the friction member configuring the clutch disc assembly. The wear-amount detecting mechanism 6 has a roll pin 14, an opposing member 16, the wedge member 15, and a first coil spring 17.

The roll pin 14 is a member in contact with the flywheel. As shown in FIG. 6, the roll pin 14 is attached, in such a way that it can freely slide, in an attachment hole formed in the pressure plate 3. A first end 14a of the roll pin 14 is in contact with the flywheel (see FIG. 6), and a second end 14b of the roll pin 14 is press-fitted in and attached to the opposing member 16 (see FIG. 5). The roll pin 14 always keeps the distance between the opposing member 16 and the flywheel at a constant by bringing the first end 14a into contact with the flywheel. The flywheel surface is indicated by a triangular symbol (the “▾” symbol) in FIG. 6.

As shown in FIG. 5 and FIG. 6, the opposing member 16 has an attachment portion 19, which is for attaching the roll pin 14, and an opposing member-use sliding portion 20, which becomes a reference when detecting the wear-amount of the friction member and is in contact with and slides against a sliding portion 21 (described later) of the wedge member 15. The second end 14b of the roll pin 14 is press-fitted in and attached to the attachment portion 19 that is a boss portion, for example. Further, in a state in which the second end 14b of the roll pin 14 has been attached to the boss portion 19 and the first end 14a of the roll pin 14 is in contact with the flywheel, the sliding portion 20 is placed opposing the pressure plate 3. In this way, the position of the opposing member 16 is always kept at a constant by the roll pin 14 in contact with the flywheel. The sliding portion 20 has a sloping surface 20a that slopes in such a way that its height becomes higher in the first circumferential direction (the direction of R1 in FIG. 3).

The wedge member 15 is a member that fits between the opposing member 16 and the pressure plate 3 (see FIG. 6), and the wedge member 15 moves in the first circumferential direction (the direction of R1 in FIG. 3 and FIG. 5) in accordance with the wear-amount of the friction member. Specifically, the wedge member 15 moves in the first circumferential direction due to the first coil spring 17 while moving in a direction away from the opposing member 16 together with the pressure plate 3 in accordance with the wear-amount of the friction member. Additionally, the wedge member 15 fits between the pressure plate 3 and the opposing member 16 and stops moving in the first circumferential direction.

As shown in FIG. 5 and FIG. 6, the wedge member 15 has a body portion 15a and an engaging portion 15b that is formed integrally with the body portion 15a and engages with the fulcrum ring. The body portion 15a is a section formed in the shape of a rod and is placed in the two rail portions 27 formed on the pressure plate 3. Specifically, the body portion 15a is placed in such a way that it can freely move in the circumferential direction between each pair of the two projecting portions 27a and 27b. The sliding portion 21 that is in contact with and slides against the sliding portion 20 of the opposing member 16 is formed on the body portion 15a. The wedge member-use sliding portion 21 has a sloping surface 21a that slopes in such a way that its height becomes lower in the first circumferential direction (the direction of R1 in FIG. 3).

Here, the sloping surface 20a of the opposing member 16 and the sloping surface 21a of the wedge member 15 are formed in such a way that the angle of inclination of the sloping surfaces 20a and 21a formed on the opposing member 16 and the wedge member 15 respectively is smaller than the angle of inclination of the sloping surfaces 10a and 11a formed on the pressure plate and the fulcrum ring 4 respectively. In other words, the sloping surfaces 10a of the pressure plate and the sloping surfaces 11a of the fulcrum ring 4 are formed in such a way that the angle of inclination of the sloping surfaces 10a and 11a formed on the pressure plate and the fulcrum ring 4 respectively is greater than the angle of inclination of the sloping surfaces 20a and 21a formed on the opposing member 16 and the wedge member 15 respectively.

It is preferred that the angle of inclination of the sloping surfaces 10a and 11a of the pressure plate and the fulcrum ring 4 respectively be set to less than 6.0 degrees, for example. Here, the angle of inclination of the sloping surfaces 10a and 11a is set to 5.6 degrees, for example. Further, it is preferred that the angle of inclination of the sloping surfaces 20a and 21a of the opposing member 16 and the wedge member 15 respectively be set to less than 5.6 degrees, for example. Here, the angle of inclination of the sloping surfaces 20a and 21a is set to 5.5 degrees, for example.

As shown in FIG. 5 and FIG. 6, the engaging portion 15b is integrally formed projecting in a direction intersecting the lengthwise direction of the body portion 15a. The engaging portion 15b is formed in the shape of an L, and its distal end portion engages with the engaging recessed portion 4c of the fulcrum ring 4. Specifically, the distal end portion of the engaging portion 15b is inserted into the engaging recessed portion 4c of the fulcrum ring 4, and the body portion 15a is put in the rail portions 27. The distal end portion of the engaging portion 15b has a width W2 in the circumferential direction. As shown in FIG. 9 and FIG. 10, the width W2 of the distal end portion of the engaging portion 15b is smaller than the width W1 of the engaging recessed portion 4c. Further, as described later, a projecting portion 91d of an engaging member is also inserted into the engaging recessed portion 4c. The projecting portion 91d has a width W3 in the circumferential direction. Because of this, the engaging portion 15b (that is, the wedge member 15) is movable in the circumferential direction in the range of (W1-W2-W3). For example, here, the engaging recessed portion 4c and the engaging portion 15b are formed in such a way that (W1-W2-W3) is a predetermined value such as 2.0 mm, for example.

The first coil spring 17 is a member that biases the wedge member 15 in the first circumferential direction. In other words, the first coil spring 17 is a member that regulates the movement of the wedge member 15 in a second circumferential direction (the opposite direction of the direction of R1). As shown in FIG. 5, one end of the first coil spring 17 is attached to the engaging portion 15b of the wedge member 15, and the other end of the first coil spring 17 is attached to the fulcrum ring 4. The first coil spring 17 biases, in the first circumferential direction (the direction of R1 in FIG. 5), the wedge member 15 placed between the pressure plate 3 and the opposing member 16. Because of this, the wedge member 15 is maintained in a state in which it is fitted between the pressure plate 3 and the opposing member 16. Additionally, when the friction member has worn, the first coil spring 17 moves the wedge member 15 in the first circumferential direction and wedges the wedge member 15 between the pressure plate 3 and the opposing member 16 in accordance with the wear-amount of the friction member.

### Wear Tracking Mechanism

The wear tracking mechanism 7 is a mechanism for tracking the wear-amount of the friction member—that is, the amount of movement of the wedge member 15—to keep the posture of the diaphragm spring 5 in its initial posture. The wear tracking mechanism 7 has, in addition to the plural fulcrum ring 4 segments, the sliding portions 10 and 11 formed on the pressure plate 3 and the fulcrum ring 4 respectively and a second coil spring 28 (see FIG. 2).

The plural fulcrum ring 4 segments are placed, in such a way as to be relatively rotatable with respect to the pressure plate 3, between the wall portion 25b of the step portion 25 of the pressure plate 3 and the guide portions 26. Further, the plural fulcrum ring 4 segments are pressed to the pressure plate 3 side by the diaphragm spring 5. Further, in the state of FIG. 6 and FIG. 10, the sloping surfaces 11a of the sliding portions 11 of the plural fulcrum ring 4 segments are in contact with the sloping surfaces 10a of the sliding portions 10 of the pressure plate 3, and the plural fulcrum ring 4 segments are movable in the first circumferential direction (the direction of R1 in FIG. 5) only an amount equal to the amount of movement of the wedge member 15. Here, the maximum value of the amount of movement of the wedge member 15 is (W1-W2-W3).

The second coil spring 28 is a member that biases the fulcrum ring 4 in the first circumferential direction. In other words, the second coil spring 28 is a member that regulates the movement of the fulcrum ring 4 in the second circumferential direction (the opposite direction of the direction of R1). The second coil spring 28 relatively rotates the fulcrum ring 4 in the first circumferential direction with respect to the pressure plate. As shown in FIG. 2, the second coil spring 28 is attached to the fulcrum ring 4 and the pressure plate 3 in such a way as to be along the inner peripheral portion of the fulcrum ring 4. Specifically, one end of the second coil spring 28 is attached to the fulcrum ring 4, and the other end of the second coil spring 28 is attached to the pressure plate 3.

In the configuration described above, in a case where the wedge member 15 has moved in the circumferential direction (the direction of R1) in accordance with the wear-amount of the friction member, an engaging member described later is movable in the rotational direction of the fulcrum ring 4 and the fulcrum ring 4 is rotationally movable only an amount equal to the amount of movement of the wedge member 15. Here, when the fulcrum ring 4 rotates with respect to the pressure plate 3, the fulcrum ring 4 moves to the side away from the pressure plate 3 in the axial direction because both members 4 and 3 are in contact with each other due to the sloping surfaces of the sliding portions 10 and 11.

### Ring Movement Regulating Mechanism

A ring movement regulating mechanism 9 is a mechanism that regulates the movement of the fulcrum ring 4 in the direction away from the pressure plate 3. Specifically, the ring movement regulating mechanism 9 regulates the movement of the fulcrum ring 4 in the direction away from the pressure plate 3 by regulating the relative rotation of the fulcrum ring 4 with respect to the pressure plate 3.

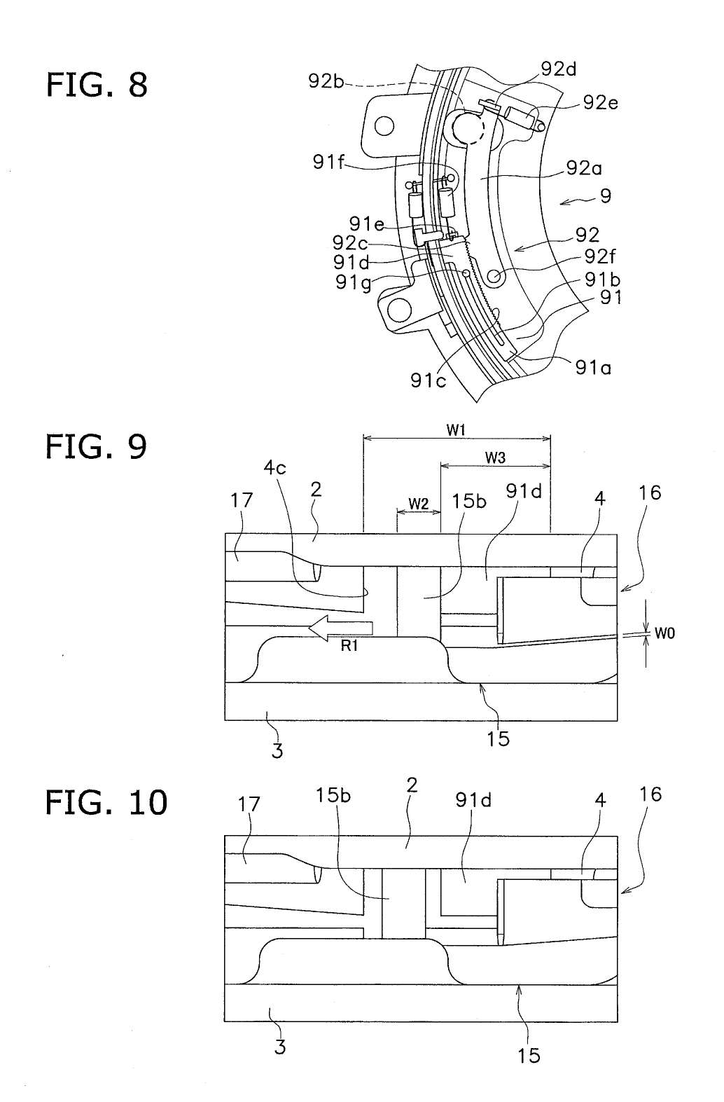

As shown in FIG. 7 and FIG. 8, the ring movement regulating mechanism 9 has an engaging member 91 that engages with the fulcrum ring 4, a regulating member 92 that engages with the engaging member 91 at the time of rotation of the pressure plate 3 and regulates the movement of the fulcrum ring 4 via the engaging member 91, a third coil spring 91f (second biasing member), and a fourth coil spring 92e (first biasing member).

The engaging member 91 is attached to the pressure plate 3 in such a way as to be movable in the rotational direction of the fulcrum ring 4. The engaging member 91 has a body portion 91a, a long hole portion 91b for attachment to the pressure plate 3, a concavo-convex portion 91c, the projecting portion 91d that engages with the engaging recessed portion 4c of the fulcrum ring 4, and a coupling portion 91e for coupling to the fulcrum ring 4.

The body portion 91a is a plate-shaped section that is long in one direction. The major axis direction of the body portion 91a corresponds to the circumferential direction of the fulcrum ring 4. The long hole portion 91b is formed in the major axis direction in the center of the surface of the body portion 91a. The concavo-convex portion 91c is formed in the major axis direction on a long edge side surface of the body portion 91a. The concavo-convex portion 91c is formed on the side surface on the inner peripheral side of the body portion 91a in a state in which the body portion 91a has been attached to the pressure plate 3. The projecting portion 91d is formed projecting outward from one end of the body portion 91a on the long edge side surface on the opposite side of the long edge side surface on which the concavo-convex portion 91c is formed. The coupling portion 91e is integrally formed on one end of the body portion 91a.

Here, by inserting a pin member 91g having a head portion that is greater in diameter than its shaft portion into the long hole portion 91b and attaching the distal end of the shaft portion of the pin member 91g to the pressure plate 3, the engaging member 91 is attached to the pressure plate 3 in such a way as to be movable in the rotational direction of the fulcrum ring 4. Further, by using the third coil spring 91f to couple together the coupling portion 91e and a pin member 91g attached to the fulcrum ring 4, the engaging member 91 is coupled to the fulcrum ring 4 and is biased in the first circumferential direction. Moreover, the projecting portion 91d of the engaging member 91 is placed between the engaging portion 15b of the wedge member 15 and the wall surface of the engaging recessed portion 4c in the second circumferential direction.

The regulating member 92 is attached, in such a way that it can freely swing, to the pressure plate 3. The regulating member 92 regulates the movement of the engaging member 91 by swinging due to centrifugal force at the time of rotation of the pressure plate and engaging with the engaging member 91. The regulating member 92 has a body portion 92a, an adjusting member 92b for adjusting the timing when the body portion 92a swings, a concavo-convex portion 92c, and a coupling portion 92d for attachment to the pressure plate 3. The body portion 92a is a plate-shaped section that is long in one direction. A through hole is formed in one end of the body portion 92a. The adjusting member 92b is a weight and is attached to the other end side of the body portion 92a. The concavo-convex portion 92c is formed in the major axis direction on a long edge side surface of the body portion 92a. The concavo-convex portion 92c is formed on the side surface on the outer peripheral side of the body portion 92a in a state in which the body portion 92a has been attached to the pressure plate 3. The coupling portion 92d is integrally formed on the other end of the body portion 92a.

Here, by inserting a pin member 92f into the through hole formed in the one end of the body portion 92a and attaching the distal end of the shaft portion of the pin member 92f to the pressure plate 3, the regulating member 92 is attached in such a way that it can freely swing with respect to the pressure plate 3. Further, by using the fourth coil spring 92e to couple together the coupling portion 92d and a pin member 92f attached to the pressure plate 3, the regulating member 92 is biased in the direction away from the engaging member 91 by the fourth coil spring 92e.

In the ring movement regulating mechanism 9 having this configuration, when the rotational speed of the pressure plate has become greater than a predetermined rotational speed, the regulating member 92 swings in the direction of the engaging member 91 due to centrifugal force and the concavo-convex portion 92c of the regulating member 92 meshes and engages with the concavo-convex portion 91c of the engaging member 91. Then, the engaging member 91 becomes immovable in the rotational direction of the fulcrum ring 4. In this way, the movement of the engaging member 91 is regulated by the regulating member 92.

The predetermined rotational speed is set to the idling engine speed. Here, the weight of the adjusting member 92b is set in such a way that the regulating member 92 swings in a case where the rotational speed of the pressure plate 3 has become greater than the idling engine speed, such as 400 rpm for example.

### Wear-Amount Detecting Action

In a state in which the clutch is on (coupled), the pressing load of the diaphragm spring 5 acts on the pressure plate 3 via the fulcrum ring 4, and because of this, the friction member of the clutch disc assembly is held between the pressure plate 3 and the flywheel. At this time, as shown in FIG. 7, the wedge member 15 is fitted between the pressure plate 3 and the opposing member 16.

When the friction member wears, the thickness of the friction member becomes thinner, so the pressure plate 3 moves to the flywheel side (the lower side in FIG. 9 and FIG. 10). Further, because the wedge member 15 is supported on the pressure plate 3, the wedge member 15 moves to the flywheel side together with the pressure plate 3 in accompaniment with the movement of the pressure plate 3. Then, an interstice W0 (see FIG. 9) corresponding to the wear-amount of the friction member arises between the wedge member 15 and the pressure plate 3. Then, the wedge member 15 moves in the direction in which it fills the interstice W0—that is, the direction of R1 in FIG. 9—due to the biasing force of the first coil spring 17.

In this way, in accordance with the wear-amount of the friction member, the wedge member 15 moves in the direction of R1 and, as shown in FIG. 10, is fitted between the pressure plate 3 and the opposing member 16. That is, the engagement between the wedge member 15 and the opposing member 16 is temporarily released by the wear of the friction member, but the wedge member 15 moves due to the biasing force of the first coil spring 17 and reengages with the opposing member 16. Because of this, even when the friction member has worn, the interval between the pressure plate 3 and the opposing member 16 is always kept at a constant by the movement of the wedge member 15.

Here, in order to facilitate description, an example of a case where the wedge member moves in accordance with the wear-amount W0 of the friction member is provided. However, this does not mean that the wedge member 15 moves in a stepwise manner; in the present embodiment, the wedge member 15 moves continuously, tracking the wear of the friction member.

### Action of Ring Movement Regulating Mechanism and Wear Tracking Action

In a state in which the clutch is off, for example, a state in which the pressure plate 3 is not rotating, as shown in FIG. 7, the engagement between the engaging member 91 and the regulating member 92 is released. In this state, the engaging member 91 is biased in the direction of R1 by the third coil spring 91f, so the projecting portion 91d of the engaging member 91 is in contact with the engaging portion 15b of the wedge member 15. Further, the fulcrum ring 4 is also biased in the direction of R1 by the second coil spring 28, so the wall surface (the wall surface in the second circumferential direction) of the engaging recessed portion 4c in the fulcrum ring 4 is in contact with the projecting portion 91d of the engagement member 91.

In a case where the rotational speed of the pressure plate 3 is equal to or less than the idling engine speed in a state in which the clutch is on, for example, a state in which the pressure plate 3 is rotating, the engagement between the engaging member 91 and the regulating member 92 is released. In this state, when the friction member wears and the thickness of the friction member becomes thinner, as shown in FIG. 9 and FIG. 10, the wedge member 15 (that is, the engaging portion 15b) is moved in the direction of R1 by the biasing force of the first coil spring 17 in accordance with the wear-amount of the friction member (for details, see “Wear-amount Detecting Action” above). Then, tracking this movement of the wedge member 15 (that is, the engaging portion 15b), the engaging member 91 (that is, the projecting portion 91d) is moved in the direction of R1 by the biasing force of the third coil spring 91f. Further, the fulcrum ring 4 is rotated in the direction of R1 by the biasing force of the second coil spring 28. Then, the projecting portion 91d of the engaging member 91 comes into contact with the engaging portion 15b of the wedge member 15, and the wall surface (the wall surface in the second circumferential direction) of the engaging recessed portion 4c in the fulcrum ring 4 comes into contact with the projecting portion 91d of the engaging member 91. This state corresponds to a state in which the interstice W0 is zero in FIG. 9.

Here, the mutual sliding portions 10 and 11 (sloping surfaces) of the fulcrum ring 4 and the pressure plate 3 are in contact with each other. For this reason, when the fulcrum ring 4 rotates as described above, the fulcrum ring 4 moves in the direction away from the pressure plate 3. That is, the fulcrum ring 4 moves to the transmission side only an amount equal to the wear-amount of the friction member. Because of this movement, the fulcrum ring 4 returns to its initial position before the friction member wore. Here, the wear-amount detecting action and the wear tracking action are performed at the same time.

In a case where the rotational speed of the pressure plate 3 is greater than the idling engine speed in a state in which the clutch is on, for example, a state in which the pressure plate 3 is rotating, as shown in FIG. 8, the regulating member 92 swings in the radial direction due to centrifugal force and the concavo-convex portion 92c of the regulating member 92 meshes with the concavo-convex portion 91c of the engaging member 91. Then, the engaging member 91 becomes immovable in the rotational direction of the fulcrum ring 4. Here, the wall surface (the wall surface in the second circumferential direction) of the engaging recessed portion 4c in the fulcrum ring 4 is in contact with the projecting portion 91d of the engaging member 91. Therefore, when the engaging member 91 becomes immovable in the rotational direction of the fulcrum ring 4, the fulcrum ring 4 also becomes immovable in the rotational direction. In this way, the movement of the fulcrum ring 4 is regulated by the regulating member 92 via the engaging member 91.

In this state, when the friction member wears and the thickness of the friction member becomes thinner, as shown in FIG. 9 and FIG. 10, the wedge member 15 is moved in the direction of R1 by the biasing force of the first coil spring 17 in accordance with the wear-amount of the friction member (for details, see “Wear-amount Detecting Action” above). In this way, in a state in which the rotational speed of the pressure plate 3 is greater than the idling engine speed, as shown in FIG. 10, the wedge member 15 moves in the direction of R1 in accordance with the wear-amount of the friction member, but the fulcrum ring 4 is relatively non-rotatable with respect to the pressure plate 3. In this state, the wear-amount detecting action is performed, but the wear tracking action is regulated by the ring movement regulating mechanism 9.

Here, when a clutch release operation is performed so that the clutch is off, the pressing on the fulcrum ring 4 by the diaphragm spring 5 is released. Additionally, when the rotational speed of the pressure plate 3 drops and the rotational speed of the pressure plate 3 becomes equal to or less than the idling engine speed, the regulating member 92 is biased in the direction away from the engaging member 91 by the biasing force of the fourth coil spring 92e and swings. Because of this, as shown in FIG. 7, the engagement between the engaging member 91 and the regulating member 92 is released. Then, the engaging member 91 is moved in the direction of R1 by the biasing force of the third coil spring 91f. Further, the fulcrum ring 4 is rotated in the direction of R1 by the biasing force of the second coil spring 28. Then, the projecting portion 91d of the engaging member 91 comes into contact with the engaging portion 15b of the wedge member 15, and the wall surface (the wall surface in the second circumferential direction) of the engaging recessed portion 4c in the fulcrum ring 4 comes into contact with the projecting portion 91d of the engaging member 91. FIG. 9 corresponds to this state. By rotating the fulcrum ring 4 in this way, as mentioned above, the fulcrum ring 4 moves in the direction away from the pressure plate 3. In this way, the movement of the fulcrum ring 4 is released in the ring movement regulating mechanism 9, and the wear tracking action is performed.

### Characteristics

(1) In the ring movement regulating mechanism 9, the regulating member 92 swings due to centrifugal force because of the rotation of the pressure plate 3 and engages with the engaging member 91. Because of this, the regulating member 92 regulates the movement of the fulcrum ring 4 via the engaging member 91. Therefore, even if vibration occurs at the time of rotation of the pressure plate 3, it becomes difficult for the fulcrum ring 4 to be affected by the vibration. In other words, when the engagement between the regulating member 92 and the engaging member 91 has been released, movement of the fulcrum ring in accordance with the wear-amount of the friction member can be performed. Therefore, wear compensation can be performed more reliably.

(2) In the ring movement regulating mechanism 9, the third coil spring 91f biases the engaging member 91 in the rotational direction of the fulcrum ring 4. Therefore, when the engagement between the regulating member 92 and the engaging member 91 has been released, the engaging member 91 can be speedily moved in the rotational direction of the fulcrum ring 4. Further, in this state, the fulcrum ring 4 is rotated in the moving direction of the engaging member 91 by the second coil spring 28 in accordance with the wear-amount of the friction member, whereby the fulcrum ring 4 can be reliably moved in the direction away from the pressure plate 3.

(3) In the ring movement regulating mechanism 9, the fourth coil spring 92e attached to the pressure plate 3 biases the regulating member 92 in the direction away from the engaging member 91, so the engagement between the regulating member 92 and the engaging member 91 can be reliably released

### Embodiment 2

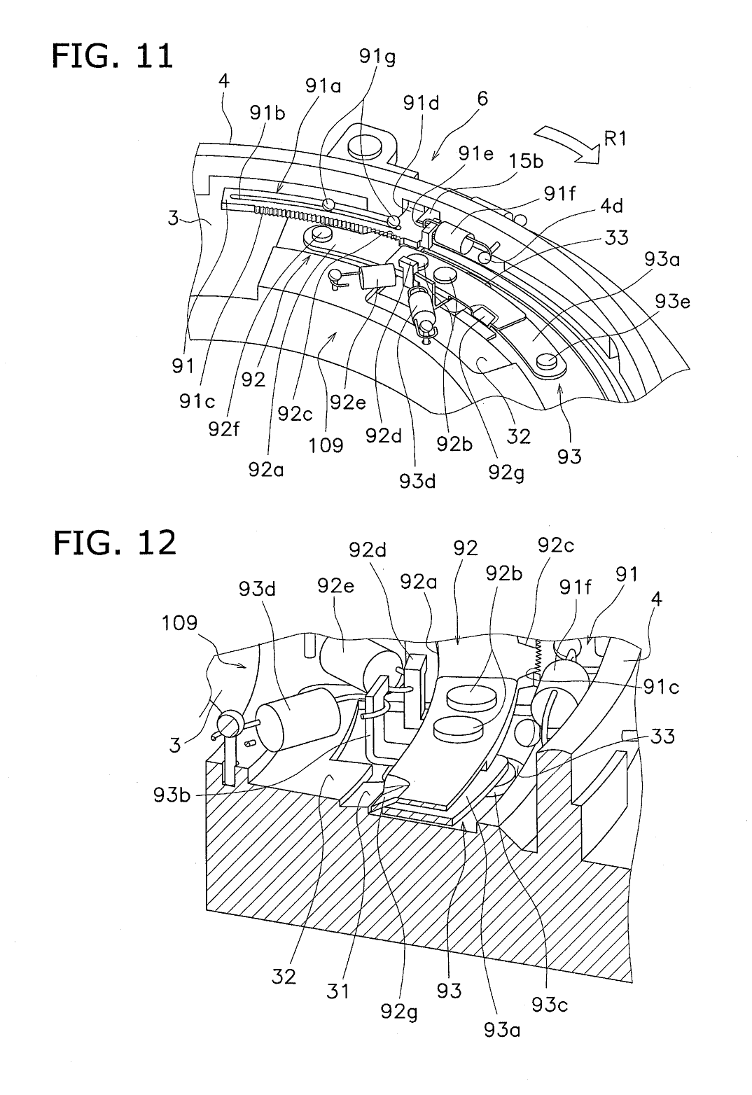

The basic configuration of the clutch cover assembly 1 pertaining to a second embodiment of the present invention is the same as that of the first embodiment, and mainly the configuration of a ring movement regulating mechanism 109 differs from that of the first embodiment. For this reason, here, detailed description of configurations that are the same as those of the first embodiment is omitted. FIG. 11 and FIG. 12 are views for describing the configuration and action of the ring movement regulating mechanism 109 according to the second embodiment. FIG. 11 is an example of a case where the ring movement regulating mechanism 109 is not functioning, and FIG. 12 is an example of a case where the ring movement regulating mechanism 109 has functioned. Further, in FIG. 11 and FIG. 12, the same reference signs are used for members that are the same as those of the first embodiment. Sometimes configurations and actions that are the same as those of the first embodiment will be described using the figures of the first embodiment.

### Pressure Plate

On the surface on the transmission side (the front side in FIG. 2) of the pressure plate 3, as shown in FIG. 3, the sliding portions 10 are formed in plural places in the circumferential direction on the outer peripheral side. Specifically, each sliding portion 10 is formed projecting outward in the axial direction from the bottom portion 25a of the step portion 25. Each sliding portion 10 has a sloping surface 10a that slopes in such a way that its height becomes higher in the first circumferential direction (the direction of R1 in FIG. 3). Further, as shown in FIG. 11 and FIG. 12, a first step portion 31 (step portion), a second step portion 32 whose step is greater than that of the first step portion 31, and a recessed portion 33 are formed in the pressure plate 3. The wall surface of the first step portion 31 and the wall surface of the second step portion 32 are formed on the pressure plate 3 in such a way as to oppose the inner peripheral surface of the fulcrum ring. Further, the upper surface of the first step portion 31 is formed sloping in such a way that its height becomes higher from the inner peripheral side toward the outer peripheral side. A release member-use adjusting member 93c (see FIG. 12) described later is placed in the recessed portion 33.

### Ring Movement Regulating Mechanism

The ring movement regulating mechanism 109 is a mechanism that regulates the movement of the fulcrum ring 4 in the direction away from the pressure plate 3. Specifically, the ring movement regulating mechanism 109 regulates the movement of the fulcrum ring 4 in the direction away from the pressure plate 3 by regulating the relative rotation of the fulcrum ring 4 with respect to the pressure plate 3.

As shown in FIG. 11 and FIG. 12, the ring movement regulating mechanism 109 has the engaging member 91 that engages with the fulcrum ring 4, the regulating member 92 that engages with the engaging member 91 at the time of rotation of the pressure plate 3 and regulates the movement of the fulcrum ring 4 via the engaging member 91, and a release member 93 that releases the engagement of the regulating member 92 with respect to the engaging member 91. Further, the ring movement regulating mechanism 109 further has the third coil spring 91f (second biasing member), the fourth coil spring 92e (first biasing member), and a fifth coil spring 93d (third biasing member).

The engaging member 91 is attached to the pressure plate 93 in such a way as to be movable in the rotational direction of the fulcrum ring 4. The engaging member 91 has the body portion 91a, the long hole portion 91b for attachment to the pressure plate 3, the concavo-convex portion 91c, the projecting portion 91d that engages with the engaging recessed portion 4c of the fulcrum ring 4, and the coupling portion 91e for coupling to the fulcrum ring 4.

Here, by inserting pin members 91g having head portions that are greater in diameter than their shaft portions into the long hole portion 91b and attaching the distal ends of the shaft portions of the pin members 91g to the pressure plate 3, the engaging member 91 is attached to the pressure plate 3 in such a way as to be movable in the rotational direction of the fulcrum ring 4. Further, by using the third coil spring 91f to couple together the coupling portion 91e and a pin member 4d attached to the fulcrum ring 4, the engaging member 91 is coupled to the fulcrum ring 4 and is biased in the first circumferential direction (the direction of R1 in FIG. 11). Moreover, the projecting portion 91d of the engaging member 91 is placed between the engaging portion 15b of the wedge member 15 and the wall surface of the engaging recessed portion 4c in the second circumferential direction (the opposite direction of the direction of R1 in FIG. 11; called “the direction of R2” below).

The regulating member 92 is attached, in such a way that it can freely swing, to the pressure plate 3. The regulating member 92 regulates the movement of the engaging member 91 by swinging due to centrifugal force at the time of rotation of the pressure plate and engaging with the engaging member 91. The regulating member 92 has the body portion 92a, the adjusting member 92b for adjusting the timing when the body portion 92a swings, the concavo-convex portion 92c, the coupling portion 92d for attachment to the pressure plate 3, and a posture holding portion 92g.

The posture holding portion 92g is for holding the posture in which the regulating member 92 is engaged with the engaging member 91. The posture holding portion 92g is extruded out of plane from the plate-shaped body portion 92a. The posture holding portion 92g is formed in the side surface of the end portion of the regulating member 92 on the opposite side of the end portion on the side where the pin member 92f is attached.

The posture holding portion 92g engages with the first step portion 31 of the pressure plate 3 (see FIG. 12). Specifically, the posture holding portion 92g engages with the wall surface of the first step portion 31 that opposes the fulcrum ring 4. In this case, the regulating member 92 regulates the movement of the engaging member 91. Further, the posture holding portion 92g engages also with the second step portion 32 of the pressure plate 3 (see FIG. 11). Specifically, the posture holding portion 92g engages with the wall surface of the second step portion 32 that opposes the fulcrum ring 4. In this case, the regulating member 92 allows the movement of the engaging member 91.

The adjusting member 92b is a weight and is attached to the body portion 92a. Here, two of the adjusting members 92b are attached to the center portion of the body portion 92a.

The release member 93 is attached, in such a way that it can freely swing, to the pressure plate 3 between the regulating member 92 and the pressure plate 3. As shown in FIG. 12, when the regulating member 92 is engaged with the engaging member 91, the release member 93 is in contact with the regulating member 92 between the regulating member 92 and the pressure plate 3. Further, the release member 93 is biased in the direction away from the engaging member 91 by the fifth coil spring 93d and swings due to the biasing force of the fifth coil spring 93d. Additionally, the release member 93 releases the engagement of the regulating member 92 with respect to the engaging member 91. Specifically, the release member 93 releases the engagement between the first step portion 31 of the pressure plate 3 and the posture holding portion 92g of the regulating member 92. The release member 93 has a body portion 93a, a coupling portion 93b, and the adjusting member 93c for adjusting the timing when the body portion 93a swings.

The body portion 93a is a plate-shaped section that is long in one direction. As shown in FIG. 11, a through hole is formed in one end of the body portion 93a, and a pin member 93e is inserted into the through hole. Additionally, by attaching the distal end of the shaft portion of the pin member 93e to the pressure plate 3, the release member 93 is attached in such a way that it can freely swing with respect to the pressure plate 3. Further, as shown in FIG. 12, when the regulating member 92 is engaged with the engaging member 91, the body portion 93a is in contact with the surface on the pressure plate side of the posture holding portion 92g. Here, when the rotational speed of the pressure plate 3 drops and the biasing force of the fifth coil spring 93d becomes greater than the centrifugal force decided by the adjusting member 93c, the body portion 93a swings in the direction away from the fulcrum ring 4 and releases the engagement between the first step portion 31 of the pressure plate 3 and the posture holding portion 92g of the regulating member 92.

As shown in FIG. 12, one end of the fifth coil spring 93d is coupled to the coupling portion 93b. Here, the other end of the fifth coil spring 93d is coupled to the pressure plate 3. Because of this, the release member 93 is biased in the direction away from the engaging member 91 by the fifth coil spring 93d. The adjusting member 93c is a member that affects the centrifugal force acting on the release member 93. The adjusting member 93c is a weight and is attached to the other end side of the body portion 93a. The adjusting member 93c is placed inside the recessed portion 33 in the pressure plate 3 in a state in which it is attached to the body portion 93a.

In the ring movement regulating mechanism 109 having this configuration, when the rotational speed of the pressure plate has become greater than the predetermined rotational speed, the regulating member 92 and the release member 93 swing in the direction of the engaging member 91 due to centrifugal force. Additionally, as shown in FIG. 12, when the posture holding portion 92g of the regulating member 92 engages with the first step portion 31, the regulating member 92 is positioned in a predetermined position. At this time, the concavo-convex portion 92c of the regulating member 92 meshes and engages with the concavo-convex portion 91c of the engaging member 91. Then, the engaging member 91 becomes immovable in the rotational direction of the fulcrum ring 4. In this way, the movement of the engaging member 91 is regulated by the regulating member 92. Further, in this state, the release member 93 is placed between the regulating member 92 and the pressure plate 3, and the release member 93 is in contact with the posture holding portion 92g of the regulating member 92.

The predetermined rotational speed is set to the idling engine speed. Here, the weight of the adjusting members 92b and the weight of the adjusting member 93c are set in such a way that the regulating member 92 and the release member 93 swing in a case where the rotational speed of the pressure plate 3 has become greater than the idling engine speed, such as 400 rpm for example.

### Action of Ring Movement Regulating Mechanism and Wear Tracking Action

In a state in which the clutch is off, for example, a state in which the pressure plate 3 is not rotating, as shown in FIG. 11, the engagement between the engaging member 91 and the regulating member 92 is released. In this state, the engaging member 91 is biased in the direction of R1 by the third coil spring 91f, so the projecting portion 91d of the engaging member 91 is in contact with the engaging portion 15b of the wedge member 15. Further, the fulcrum ring 4 is also biased in the direction of R1 by the second coil spring 28 shown in FIG. 2, so the wall surface (the wall surface in the direction of R2) of the engaging recessed portion 4c in the fulcrum ring 4 is in contact with the projecting portion 91d of the engaging member 91.

In a case where the rotational speed of the pressure plate 3 is equal to or less than the idling engine speed in a state in which the clutch is on, for example, a state in which the pressure plate 3 is rotating, the engagement between the engaging member 91 and the regulating member 92 is released. In this state, when the friction member wears and the thickness of the friction member becomes thinner, as shown in FIG. 9 and FIG. 10, the wedge member 15 (that is, the engaging portion 15b) and the engaging member 91 (that is, the projecting portion 91d) are moved in the direction of R1 by the biasing force of the first coil spring 17 and the biasing force of the third coil spring 91f in accordance with the wear-amount of the friction member. Additionally, the fulcrum ring 4 is also rotated in the direction of R1 by the biasing force of the second coil spring 28. Because of this, the projecting portion 91d of the engaging member 91 comes into contact with the engaging portion 15b of the wedge member 15, and the wall surface (the wall surface in the direction of R2) of the engaging recessed portion 4c in the fulcrum ring 4 comes into contact with the projecting portion 91d of the engaging member 91.

Here, when the fulcrum ring 4 rotates, the fulcrum ring 4 moves in the direction away from the pressure plate 3. That is, the fulcrum ring 4 moves to the transmission side only an amount equal to the wear-amount of the friction member. Because of this movement, the fulcrum ring 4 returns to its initial position before the friction member wore. Here, the wear-amount detecting action and the wear tracking action are performed at the same time.

In a case where the rotational speed of the pressure plate 3 is greater than the idling engine speed in a state in which the clutch is on, for example, a state in which the pressure plate 3 is rotating, the regulating member 92 and the release member 93 swing in the radial direction due to centrifugal force, and as shown in FIG. 12, the concavo-convex portion 92c of the regulating member 92 meshes with the concavo-convex portion 91c of the engaging member 91. Then, the engaging member 91 becomes immovable in the rotational direction of the fulcrum ring 4. Here, the wall surface (the wall surface in the direction of R2) of the engaging recessed portion 4c in the fulcrum ring 4 is in contact with the projecting portion 91d of the engaging member 91. Therefore, when the engaging member 91 becomes immovable in the rotational direction of the fulcrum ring 4, the fulcrum ring 4 also becomes immovable in the rotational direction. In this way, the movement of the fulcrum ring 4 is regulated by the regulating member 92 via the engaging member 91.

In this state, when the friction member wears and the thickness of the friction member becomes thinner, as shown in FIG. 9 and FIG. 10, the wedge member 15 is moved in the direction of R1 by the biasing force of the first coil spring 17 in accordance with the wear-amount of the friction member. In this way, in a state in which the rotational speed of the pressure plate 3 is greater than the idling engine speed, the wedge member 15 moves in the direction of R1 in accordance with the wear-amount of the friction member, but the fulcrum ring 4 is relatively non-rotatable with respect to the pressure plate 3. In this state, the wear-amount detecting action is performed, but the wear tracking action is regulated by the ring movement regulating mechanism 109.

Here, when a clutch release operation is performed so that the clutch is off, the pressing on the fulcrum ring 4 by the diaphragm spring 5 is released. Additionally, when the rotational speed of the pressure plate 3 drops and the rotational speed of the pressure plate 3 becomes equal to or less than the idling engine speed, the release member 93 is biased in the direction away from the engaging member 91 by the biasing force of the fifth coil spring 93d and swings. Then, the posture holding portion 92g of the regulating member 92 is pressed up by the body portion 93a of the release member 93 and the engagement between the posture holding portion 92g and the first step portion 31 is released. Then, the posture holding portion 92g of the regulating member 92 comes into contact with the wall surface of the second step portion 32 (for example, the wall surface that opposes the fulcrum ring 4), and the swinging of the release member 93 stops. Further, after the body portion 93a of the release member 93 presses up the posture holding portion 92g of the regulating member 92, the body portion 93a comes into contact with the wall surface of the first step portion 31 (for example, the wall surface that opposes the fulcrum ring 4), and the swinging of the release member 93 stops. This state is a state in which the release member 93 has released the engagement of the regulating member 92 with respect to the engaging member 91.

In this way, when the engagement between the engaging member 91 and the regulating member 92 is released, the engaging member 91 and the fulcrum ring 4 are rotated in the direction of R1 by the biasing force of the third coil spring 91f and the biasing force of the second coil spring 28. Then, the projecting portion 91d of the engaging member 91 comes into contact with the engaging portion 15b of the wedge member 15, and the wall surface (the wall surface in the direction of R2) of the engaging recessed portion 4c in the fulcrum ring 4 comes into contact with the projecting portion 91d of the engaging member 91. FIG. 11 corresponds to this state. When the fulcrum ring 4 rotates in this way, the fulcrum ring 4 moves in the direction way from the pressure plate 3 as described above. In this way, in the second embodiment, the movement of the fulcrum ring 4 is released in the ring movement regulating mechanism 109, and the wear tracking action is performed.

### Characteristics

(1) In the ring movement regulating mechanism 109, when the posture holding portion 92g of the regulating member 92 is engaged with the first step portion 31 of the pressure plate 3, the posture in which the regulating member 92 is engaged with the engaging member 91 is held. Further, when the release member 93 has swung in the direction away from the engaging member 91 due to the fifth coil spring 93d, the engagement between the regulating member 92 and the engaging member 91 is released. Because of this, when the effect of vibration is large, the posture in which the regulating member 92 is engaged with the engaging member 91 is held, so the movement of the fulcrum ring 4 can be regulated. Further, when the effect of vibration is small, the engagement between the regulating member 92 and the engaging member 91 can be released, and the wear tracking mechanism 7 can be allowed to act. In this way, wear compensation can be performed more safely and accurately.

Here, in regard to sections whose configurations are the same as those of the first embodiment, effects that are the same as the effects described above can be obtained.

### Other Embodiments

The present invention is not limited to the embodiments described above and is capable of a variety of modifications and improvements without departing from the scope of the present invention.

(a) The configuration of the wear tracking mechanism can be any configuration provided that it is a configuration that acts in such a way as to maintain the initial posture of the diaphragm spring, and is not limited to the embodiments described above.

### INDUSTRIAL APPLICABILITY

In the present invention, the movement of the fulcrum ring at the time of rotation of the pressure plate is regulated by the ring movement regulating mechanism. Therefore, even if vibration occurs at the time of rotation of the pressure plate, it becomes difficult for the fulcrum ring to be affected by the vibration. That is, in the present invention, the effect of vibration can be eliminated by the ring movement regulating mechanism, so accurate wear compensation can be performed.

1. A clutch cover assembly for pressing a friction member of a clutch disc assembly against a flywheel of an engine and releasing the pressing, the clutch cover assembly comprising:
a clutch cover being fixed to the flywheel;
a pressure plate being coupled to the clutch cover being relatively non-rotatable with respect to the clutch cover, and being configured to press the friction member against the flywheel;
a fulcrum ring being disposed on the pressure plate and configured to move in a direction away from the pressure plate in accordance with an wear-amount of the friction member; and
a ring movement regulating mechanism being configured to regulate movement of the fulcrum ring in the direction away from the pressure plate in a state in which a rotational speed of the pressure plate is over a predetermined rotational speed.

2. The clutch cover assembly according to claim 1, wherein
the ring movement regulating mechanism includes
an engaging member being configured to engage with the fulcrum ring and
a regulating member being configured to engage with the engaging member and regulate the movement of the fulcrum ring via the engaging member in the state in which the rotational speed of the pressure plate is over the predetermined rotational speed.

3. The clutch cover assembly according to claim 2, wherein
the fulcrum ring is configured to move in the direction away from the pressure plate by relatively rotating with respect to the pressure plate in accordance with the wear-amount of the friction member,
the engaging member is attached to the pressure plate and is movable in a rotational direction of the fulcrum ring, and
the regulating member is attached swingably to the pressure plate and is configured to regulate the movement of the engaging member by swinging and engaging with the engaging member in the state in which the rotational speed of the pressure plate is over the predetermined rotational speed.

4. The clutch cover assembly according to claim 3, wherein
the regulating member includes an adjusting member, and
weight of the adjusting member is adjusted in such a way that the regulating member swings due to centrifugal force when the rotational speed of the pressure plate exceeds the predetermined rotational speed.

5. The clutch cover assembly according to claim 3, wherein
the ring movement regulating mechanism further includes a first biasing member, and
the first biasing member is attached to the pressure plate and configured to bias the regulating member in a direction away from the engaging member.

6. The clutch cover assembly according to claim 3, wherein
the ring movement regulating mechanism further includes a second biasing member, and
the second biasing member is configured to bias the engaging member in the rotational direction of the fulcrum ring.

7. The clutch cover assembly according to claim 2, wherein
the ring movement regulating mechanism further includes
a release member being configured to release the engagement of the regulating member with respect to the engaging member, and
a third biasing member being configured to bias the release member in the direction away from the engaging member, and
the release member is in contact with the regulating member, is biased in the direction away from the engaging member by the third biasing member, and is configured to release the engagement of the regulating member with respect to the engaging member.

8. The clutch cover assembly according to claim 7, wherein
the pressure plate includes a step portion thereon,
the regulating member includes a posture holding portion thereon,
the posture holding portion is configured to engage with the step portion and to hold a posture in which the regulating member is engaged with the engaging member,
the release member is attached swingably to the pressure plate between the regulating member and the pressure plate, and
the release member is configured to be swung in the direction away from the engaging member by the third biasing member and to release the engagement between the step portion of the pressure plate and the posture holding portion of the regulating member.

9. The clutch cover assembly according to claim 1, further comprising
a pressing member being configured to be supported on the clutch cover and press the pressure plate to the flywheel side,
an wear-amount detecting mechanism being configured to detect the wear-amount of the friction member in a state in which the friction member is pressed against the flywheel, and
a wear tracking mechanism and being configured to move the pressing member by moving the fulcrum ring in the direction away from the pressure plate in accordance with the wear-amount of the friction member in a state in which the pressing of the friction member against the flywheel is released.

10. The clutch cover assembly according to claim 9, wherein
the wear tracking mechanism further includes
sliding portions being formed on the pressure plate and the fulcrum ring and configured to be in contact with and to slide against each other, and
a fourth biasing member being configured to bias the fulcrum ring in a circumferential direction and relatively rotate the fulcrum ring with respect to the pressure plate,
the sliding portions includes sloping surfaces,
the sloping surfaces slope along the circumferential direction, and
the fourth biasing member is configured to move the fulcrum ring in the direction away from the pressure plate by rotating the fulcrum ring in accordance with the wear-amount of the friction member.
